(19) United States
(12) Patent Application Publication
(10) Pub. No.: US 2015/0277769 A1
(43) Pub. Date: Oct. 1, 2015

(54) SCALE-OUT STORAGE IN A VIRTUALIZED STORAGE SYSTEM

(71) Applicant: EMC Corporation, Hopkinton, MA (US)

(72) Inventors: Feng Guo, Shanghai (CN); Chris You Zhou, Shanghai (CN); Feng Zhang, Shanghai (CN); Yinlong Lu, Shanghai (CN); Jie Zeng, Shanghai (CN); Peter Shuai Huang, Shanghai (CN)

(21) Appl. No.: 14/669,444

(22) Filed: Mar. 26, 2015

(30) Foreign Application Priority Data
Mar. 28, 2014 (CN) 201410135651.1

(51) Int. Cl. G06F 3/06

(52) U.S. Cl. CPC G06F 3/061; G06F 3/0665; G06F 3/0689; G06F 3/0653; G06F 2003/0692

(57) ABSTRACT

Embodiments of the present disclosure disclose a method and apparatus for storage scale-out in a virtualized storage system where in responsive to at least one new virtual storage control device being added, configuring at least a part of a virtual logic unit number configured in at least one existing virtual control device into the at least one new virtual storage control device; and responsive to the configuring, updating an access path for the at least part of the virtual logic unit number, the access path indicating all virtual storage control devices configured with the at least a part of the virtual logic unit number, and load of at least one virtual storage control device may be distributed onto more virtual storage control devices, such that data may be accessed through more virtual storage control devices, thereby preventing a single virtual storage control device from becoming a bottleneck for system performance.

### RELATED APPLICATIONS

This application claims priority from Chinese Patent Application Number CN201410135651.1 filed on Mar. 28, 2014 entitled “METHOD AND APPARATUS OF STORAGE EXPANSION IN VIRTUAL STORAGE SYSTEM” the content and teachings of which is herein incorporated by reference in its entirety.

### FIELD OF THE DISCLOSURE

Embodiments of the present disclosure relate to the field of data storage technique, and more specifically, relate to storage scale-out in a virtualized storage system.

### BACKGROUND OF THE DISCLOSURE

In the current era of information explosion, data volume as needed and generated has increased more significantly than ever before. Accordingly, data storage techniques have developed from initial integrating one single hard disk into a system to directly connecting storage devices to a scale-out port of a server or a client, and then connecting a storage system to the server and the client through a scalable network topological structure.

A storage area network (SAN) is a network storage architecture connecting a storage system to a server or a client through a scale-out network topological structure. The SAN may centralize data storage and management into a network relatively independent of the server and therefore has a higher scalability and usability.

### SUMMARY OF THE DISCLOSURE

In order to solve potential issues with respect to a SAN infrastructure, embodiments of the present disclosure provide a method and apparatus for storage scale-out in a virtualized storage system preventing a virtual storage control device from becoming the bottleneck for the storage system and affecting the storage performance.

According to a first aspect of the present disclosure, there is provided a method of storage scale-out in a virtualized storage system, wherein the virtualized storage system comprises at least one virtual control device and at least one storage device, and the at least one virtual storage control device is configured to perform virtualized management on the at least one storage device wherein responsive to at least one new virtual storage control device being added, configuring at least a part of a virtual logic unit number configured in at least one existing virtual control device into the at least one new virtual storage control device; and responsive to the configuring, updating an access path for the at least part of the virtual logic unit number, wherein the access path indicates all virtual storage control devices configured with the at least part of the virtual logic unit number.

According to a second aspect of the present disclosure, there is provided an apparatus for storage scale-out in a virtualized storage system, wherein the virtualized storage system comprises at least one virtual control device and at least one storage device, and the at least one virtual storage control device is configured to perform virtualized management on the at least one storage device wherein a configuring unit configured to, responsive to at least one new virtual storage control device being added, configure at least a part of a virtual logic unit number configured in at least one existing virtual control device into the at least one new virtual storage control device; and responsive to the configuring, update an access path for the at least part of the virtual logic unit number, the access path indicating all virtual storage control devices configured with the at least part of the virtual logic unit number.

According to a third aspect of the present disclosure, there is provided a non-transient computer readable storage medium having computer program instructions embodied thereon. The computer program instructions, when being executed, cause a machine to perform the method according to the first aspect of the present disclosure.

It will be understood through the following description that according to the embodiments of the present disclosure, load of at least one virtual storage control device may be distributed on more virtual storage control devices, such that data may be accessed through more virtual storage control devices, thereby preventing a single virtual storage control device from becoming a bottleneck for system performance.

### BRIEF DESCRIPTION OF THE ACCOMPANYING DRAWINGS

The above and other features, advantages and aspects of various embodiments of the present disclosure will become more apparent through the following detailed description with reference to the accompanying drawings. In the accompanying drawings, same or similar reference numerals represent same or similar elements, wherein:

FIG. 1 shows a schematic diagram of a virtualized storage environment in which the embodiments of the present disclosure may be implemented;

FIG. 2 shows a flow diagram of a method of scale-out storage in a virtualized storage system according to one embodiment of the present disclosure; and

FIG. 3 shows a block diagram of an apparatus for scale-out storage in a virtualized storage system according to one embodiment of the present disclosure.

### DETAILED DESCRIPTION

Embodiments of the present disclosure will be described in detail with reference to the accompanying drawings. Although some embodiments of the present disclosure have been displayed in the accompanying drawings, it should be understood that the present disclosure can be implemented in various forms, rather than being limited to embodiments described here. On the contrary, providing these embodiments is to make the present disclosure understood more thoroughly and completely. It should be understood that the accompanying drawings and embodiments of the present disclosure are merely for illustration, rather than limiting the protection scope of the present disclosure.

Generally speaking, all terms used in this text should be understood according to their general meanings in the art unless otherwise explicitly defined. All mentioned “a/an/the/said element, device, component, apparatus, unit, step, etc.” should be construed as at least one instance of the aforesaid element, device, component, apparatus, unit, step, etc., and is not excluded to comprise a plurality of such elements, devices, components, apparatuses, units, steps, etc., unless otherwise explicitly indicated.

Various embodiments of the present disclosure will be described below in detail by examples in conjunction with the accompanying drawings.

In network storage architecture such as SAN, a virtual storage control device may be used to perform virtualized management of storage. In such storage architecture, a typical network topological structure may comprise a virtual storage control device that may be connected to a plurality of storage devices and may also serves a plurality of servers. The virtual storage control device may virtualize a bottom-layer storage device into a virtualized logic unit number (LUN), such that the server may operate storage devices connected via a network like operating a local storage device. Compared with conventional approaches, such a virtualization approach enables provisioning of some more flexible operations, e.g., dynamically scaling out the capacity of LUN, and the like.

With constant increase of traffic demands, it becomes necessary to constantly scale out the storage system so as to cope with challenges of data storage in terms of capacity, bandwidth, computing capabilities, or even return of investment on the information technology (IT) investments. The scale-out capability has become an important measure of a storage system.

A typical storage scale-out approach is scaling out the storage system by increasing the number of physical storage devices such as controller buffer, hard disk, and the like. In a virtual storage environment including a virtual storage control device as mentioned above, with the gradual enlargement of the storage system, the data storage-related operations that need to be controlled by the virtual storage control device may also considerably increase, because all data stored in a storage device connected to the virtual storage control device must be accessed via the virtual storage control device. Therefore, in the terms of both the computing capabilities and the bandwidth, the virtual storage control device may become a performance bottleneck for the whole storage system. For example, the maximum input/output operations per second (IOPS) of the whole storage system may be limited to the IOPS of the virtual storage control device. Specifically, even if the expected IOPS of the storage device attached to the storage system may be greater than the IOPS of the virtual storage control device, the maximum IOPS that may be reached by the whole storage system may not exceed the IOPS of the virtual storage control device.

There is therefore a need for a solution to address the above scenario where the virtual storage control device is likely becomes a bottleneck for the storage system and affect the storage performance.

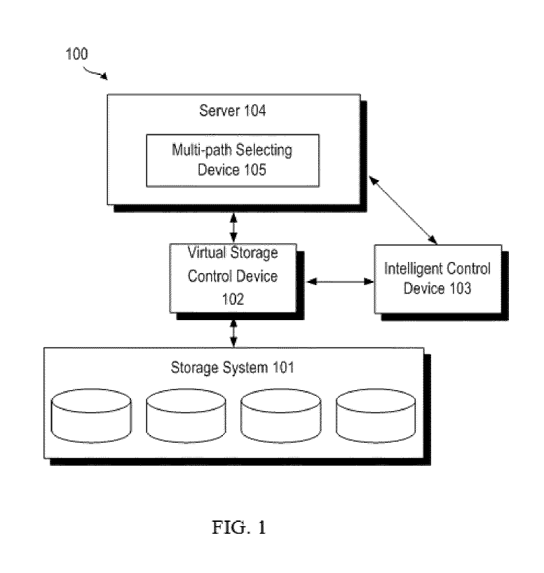

Reference is first made to FIG. 1, where a schematic diagram of a virtualized storage environment in which the embodiments of the present disclosure may be implemented is shown.

As shown in FIG. 1, virtualized storage environment 100 may comprise a storage system 101. Storage system 101 may comprise one or more storage devices. The storage devices may comprise, e.g., a solid state disk (SSD), a fiber channel (FC) disk, a serial advanced technique attachment (SATA), a serial connection small computer system interface (SCSI) (SAS) disk or a tape library, etc.

The virtualized storage environment 100, may comprise at least one virtual storage control device 102. Virtual storage control device 102 is configured to perform virtualized management on a storage device. For example, in the embodiments in accordance with the present disclosure, virtual storage control device 102 may virtualize the storage device connected thereto into a virtual LUN, such that the server or client may operate the storage device connected via virtual storage control device 102 like operating a local storage device. When virtual storage control device 102 virtualizes the storage device connected thereto to generate the virtual LUN, one virtual LUN may correspond to one or more storage devices; or alternatively, one virtual LUN may correspond to a part of a storage device or a plurality of parts of a plurality of storage devices. However, as those skilled in the art may understand, the virtual storage control device may perform virtualized management on the storage device in any other ways, and the scope of the present disclosure is not limited in this regard.

As mentioned above, since all data stored in the storage device connected to the virtual storage control device are accessed through the virtual storage control device, such that the virtual storage control device may in all probability become a performance bottleneck for the whole storage system. For example, the bandwidth, the computing capabilities and other performance of the storage system will be limited to and/or by the performance of the virtual storage control device. According to one embodiment of the present disclosure, when a virtual storage control device becomes a bottleneck of system performance due to too high load, a new virtual storage control device may be added to share the load of the virtual storage control device that becomes a bottleneck of system performance.

As shown in FIG. 1, in the virtualized storage environment 100, there may further comprise an intelligent control device 103. According to one embodiment of the present disclosure, intelligent control device 103 may assist in achieving load balance between virtual storage control devices. According to one embodiment of the present disclosure, intelligent control device 103 may be implemented in virtual storage control device 102. Alternatively, intelligent control device 103 may be implemented as a stand-alone device separate from virtual storage control device 102. The scope of the present disclosure is not limited in this regard.

Virtualized storage environment 100 may comprise one or more hosts 104. Host 104 may comprise a processing unit, a memory, a network adapter, etc. (not shown in the figure). Host 104 may access the data stored in the storage system through a virtual LUN created through virtual storage control device 102.

Additionally, virtualized storage environment 100 as shown in FIG. 1 may further comprise a multi-path selecting device 105. Multi-path selecting device 105 is configured to, when a plurality of paths are available for accessing the virtual LUN created by the virtual storage controller, select one path for access from a plurality of paths. According to one embodiment of the present disclosure, multi-path selecting device 105 may be implemented in host 104. Alternatively, multi-path selecting device 105 may be also be implemented as a stand-alone device separate from host 104. The scope of the present disclosure is not limited in this regard.

In some descriptions below, several embodiments of the present disclosure will be discussed in virtualized storage environment 100 shown in FIG. 1. However, it should be noted that this is only for the purpose of clear illustration, and not intended to limit the scope of the present disclosure in any way. On the contrary, the embodiments of the present disclosure may be applied to any virtualized storage environment that already exists in the prior art or may be developed in the future.

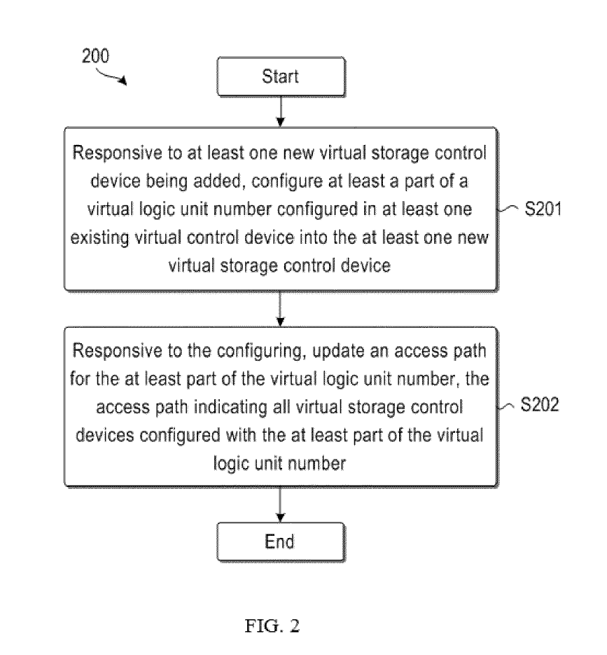

Now, reference is made to FIG. 2, where a flow diagram of an exemplary method of scale-out storage in a virtualized storage system according to one embodiment of the present disclosure is presented. In one embodiment of the present disclosure, the virtualized storage system may be located within the virtualized storage environment as shown in FIG. 1. Specifically, the virtualized storage system may comprise a storage system 101 and one or more virtual storage control devices 102. Storage system 101 may comprise one or more storage devices, and virtual storage control device 102 may perform virtualized management on these storage devices.

As shown in FIG. 2, after method 200 starts, in step S201, responsive to at least one new virtual storage control device being added, at least a part of a virtual LUN configured in at least one existing virtual control device is configured into the at least one new virtual storage control device.

As mentioned above, virtual storage control device 102 may virtualize the storage device connected thereto to generate a virtual LUN, such that all accesses to the virtual LUN have to be performed through virtual control device 102. If the access to the virtual LUN is too frequent, e.g., the IPOS is larger than the IOPS that can be provided by virtual storage control device 102, then virtual storage control device 102 may in all probability become a bottleneck of the whole system. Intelligent control device 103 may distribute the load on at least one existing virtual storage control device to the newly added virtual storage control device, thereby preventing a certain virtual storage control device from becoming a bottleneck for system performance.

Next, method 200 proceeds to step S202, wherein responsive to the configuring, an access path for the at least part of the virtual LUN is updated, wherein the access path indicates all virtual storage control devices configured with the at least part of the virtual LUN.

In one embodiment of the present disclosure, when host 104 is accessing a part of the virtual LUN for example due to executing data read/write, intelligent control device 103 may update in real-time the access path for that part of the virtual LUN, such that host 104 may obtain real-time information of the access path. Alternatively, in another embodiment of the present disclosure, intelligent control device 103 may initiate the update responsive to the access request from host 104. It should be understood that the trigger time for the updating operation of intelligent control device 103 may be set flexibly according to the needs, which in one embodiment may be pre-defined, and the scope of the present disclosure is not limited in this regard.

According to the embodiments of the present disclosure, the load of at least one virtual storage control device may be distributed on more virtual storage control devices, such that the host may perform read/write on some data through more virtual storage control devices, thereby preventing a single virtual storage control from becoming a bottleneck of the system performance.

According to the embodiments of the present disclosure, optionally, in step S201, intelligent control device 103 may monitor load of an existing virtual storage control device and determine, based on the monitored load, the existing virtual storage control device and the at least one part of the virtual LUN configured in the existing virtual storage control device for performing the configuring.

In one embodiment, a part or all of the virtual LUN configured in the virtual storage control device whose load is too high, e.g., exceeding a predetermined threshold, may be configured into the newly added one or more virtual storage control devices. Alternatively, the loads of virtual storage control devices may be ranked, and a part of the virtual LUN configured in a plurality of virtual storage control devices whose loads rank top may be configured into the newly added one or more virtual storage control devices. It should be understood that the specific configuration approaches may be flexibly set according to the needs or other pre-defined criteria, and the scope of the present disclosure is not limited in this regard.

In one embodiment of the present disclosure, the load may be access frequency, e.g., IPOS; or alternatively, the load may be data traffic for access. In this way, the load of a virtual storage control device whose load has already been very high may be distributed on the newly added virtual storage control device, thereby preventing the virtual storage control device whose load has already been very high from becoming a bottleneck for system performance.

In one embodiment of the present disclosure, optionally, in step S201, at least one new virtual storage control device may be added based on the load of an existing virtual storage control device. In one embodiment of the present disclosure, a decision on whether to add a new virtual storage control device may be determined based on comparison between the load of the existing virtual storage control device and a predetermined threshold, and on determining of a new virtual storage control device to be added, the number of new virtual storage control devices to be added is determined.

In one embodiment of the present disclosure, alternatively, method 200 may further comprise the following step: intelligent control device 103 may monitor a load of at least one virtual storage control device in a virtualized storage system, and configure, based on the monitored load, at least a part of the virtual LUN configured in the at least one virtual storage control device into at least one further virtual storage control device. In this way, load balance between virtual storage control devices may be implemented. The load balance operation here may be performed similar to the process of distributing the load of an existing virtual storage control device onto the newly added virtual storage control device. For the sake of conciseness, the details will not be described here.

In one embodiment of the present disclosure, optionally, method 200 may further comprise the following step: when a part of the virtual LUN is to be accessed, multi-path selecting device 105 selects a path for accessing the part of the virtual LUN based on the updated access path.

As described above, according to the embodiments of the present disclosure, the virtual LUN configured in one virtual storage control device may be distributed into a plurality of virtual storage control device. In this way, the access path to the virtual LUN is extended into multiple paths. In this case, when the host is to access the virtual LUN, it needs to select a path for performing access.

In one embodiment of the present disclosure, multi-path selecting device 105 performs path selection based on the load of the virtual storage control device. For example, multi-path selecting device 105 may select a virtual storage control device with a lighter load to provide service. In another embodiment of the present disclosure, multi-path selecting device 105 may also attempt an access through different virtual storage control devices in turns. In another embodiment of the present disclosure, multi-path selecting device 105 may select a path with a less delay. It should be understood that the specific selecting manner may be set flexibly according to the needs or any other pre-defined requirements/criteria, and the scope of the present disclosure is not limited in this regard.

In one embodiment of the present disclosure, optionally, method 200 may further comprise the following step: when a part of the virtual LUN is being accessed, synchronization is performed among all virtual storage control devices configured with the part of the virtual LUN to coordinate the access. In this way, it is enabled that only one virtual storage control device provides a data access service at one time, thereby preventing confliction in accessing the part of the virtual LUN.

In one embodiment of the present disclosure, a cache may be maintained in virtual storage control device 102 for caching the accessed data and relevant configuration information. The synchronization operation may be performed by synchronizing the caches maintained in individual virtual storage control devices. However, the data access may be coordinated by adopting any appropriate synchronization approach of virtual storage control devices according to the needs or any other pre-defined criteria, and the scope of the present disclosure is not limited in this regard.

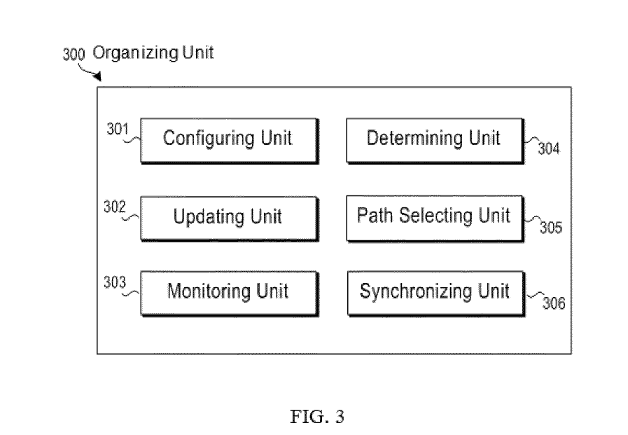

The method of storage scale-out in a virtualized storage system according to the embodiments of the present disclosure is described above with reference to FIG. 2. Now, an apparatus capable of implementing method 200 will be described with reference to FIG. 3.

FIG. 3 shows a block diagram of an apparatus for scale-out storage in a virtualized storage system according to one embodiment of the present disclosure.

The apparatus 300 as shown in FIG. 3 comprises a configuring unit 301 and an updating unit 302. In one embodiment of the present disclosure, configuring unit 301 may be configured to, responsive to at least one new virtual storage control device being added, configure at least a part of a virtual LUN configured in at least one existing virtual control device into the at least one new virtual storage control device. Updating unit 302 may be configured to, responsive to the configuring performed by the configuring unit 301, update an access path for the at least part of the virtual LUN, wherein the access path indicates all virtual storage control devices configured with the at least part of the virtual LUN.

In one embodiment of the present disclosure, the apparatus 300 may further comprise a monitoring unit 303 and a determining unit 304. In one embodiment of the present disclosure, monitoring unit 303 may monitor a load of an existing virtual storage control device. Determining unit 304 may determine, based on the monitored load, the existing virtual storage control device and the at least part of the virtual LUN configured in the existing virtual storage control device for which the configuring is performed.

In one embodiment of the present disclosure, monitoring unit 303 may further monitor a load of at least one virtual storage control device in the virtualized storage system. Configuring unit 304 may also configure, based on the monitored load, at least a part of the virtual LUN configured in the at least one virtual storage control device into at least one further virtual storage control device.

In one embodiment of the present disclosure, the apparatus 300 may further comprise a path selecting unit 305. Path selecting unit 305 may select a path for accessing the part of the virtual LUN based on the updated access path when the part of the virtual LUN is to be accessed.

In one embodiment of the present disclosure, the apparatus 300 may further comprise a synchronizing unit 306. Synchronizing unit 306 may perform, when a part of the virtual LUN is accessed, metadata synchronization among all virtual storage control devices configured with the part of the virtual LUN to coordinate the access. In one embodiment, configuring unit 301, updating unit 302, monitoring unit 303, determining unit 304, path selecting unit 305 and synchronizing unit 306 may be clubbed into an organizing unit that comprises each of these sub units functionalities built into the organizing unit, and the organizing unit being configured to perform the tasks of each of the individual sub units as required.

According to the embodiments of the present disclosure, apparatus 300 as shown in FIG. 3 may be implemented in a distributed mode on virtual storage control device 102, intelligent control device 103, and multi-path selecting device 105 as shown in FIG. 1. Alternatively, apparatus 300 may also be centrally implemented on virtual storage control device 102 or implemented as a stand-alone apparatus separate from the virtual storage control device. The scope of the present disclosure is not limited in this regard.

It should be understood that respective units recited in apparatus 300 correspond to respective steps in method 200 as described with reference to FIG. 2. Thus, the operations and features described above in conjunction with FIG. 2 are also applicable to the apparatus 300 and the units comprised therein with the same effects. The details will not be described herein.

Exemplary embodiments of the present disclosure are described above with reference to the flowchart of the method and the block diagram of the apparatus. It should be understood that the function and/or apparatus represented by each block in the flowchart and the block diagram may be implemented by means of hardware, for example, an Integrated Circuit (IC), an Application-Specific Integrated Circuit (ASIC), a general-purpose integrated circuit, a Field Programmable Gate Array (FPGA), etc.

Alternatively or additionally, part or all of the functions of the present disclosure may further be implemented by computer program instructions. For example, embodiments of the present disclosure comprise a non-transient computer readable storage medium having stored thereon computer program instructions that, when being executed, enable a machine to perform the steps of the method 200 as described above. Such a computer readable storage medium may comprise a magnetic storage medium such as a hard disk drive, a floppy disk, a tape, etc., an optical storage medium such as an optical disk, etc., and a volatile or non-volatile memory device such as an Electrically Erasable Programmable Read-Only Memory (EEPROM), a Read Only Memory (ROM), a Programmable Read-Only Memory (PROM), a Random Access Memory (RAM), a Dynamic Random Access Memory (DRAM), a Static Random Access Memory (SRAM), a flash memory, a firmware, a programmable logic, etc. The computer program instructions may be loaded to a general-purpose computer, a special-purpose computer or other programmable data processing devices so that the instructions, when being executed by the computer or other programmable data processing devices, may generate means for executing the functions specified in the blocks in the flowchart. The computer program instructions may be written by one or more program design languages or a combination thereof.

Although operations are illustrated in a specific order in the accompanying drawings, it should not be understood as, in order to obtain a desired result, it is necessary to perform these operations in the specific order as illustrated or sequentially, or it is necessary to perform all operations. In some cases, multitask or parallel processing may be beneficial.

Respective embodiments of the present disclosure have been described for the purpose of illustration, but the present disclosure is not intended to be limited to these disclosed embodiments. Without departure from the essence of the present disclosure, all modifications and changes fall into the protection scope of the present disclosure defined by the claims.

I/We claim:

1. A method of storage scale-out in a virtualized storage system, the virtualized storage system comprising at least one virtual storage control device and at least one storage device, the at least one virtual storage control device being configured to perform virtualized management on the at least one storage device, the method comprising:
responsive to at least one new virtual storage control device being added to a virtualized storage system, configuring at least a part of a virtual logic unit number configured in at least one existing virtual control device into the at least one new virtual storage control device; and
responsive to the configuring, updating an access path for the at least one part of the virtual logic unit number, the access path indicating all virtual storage control devices configured with the at least part of the virtual logic unit number.

2. The method according to claim 1, further comprising:
monitoring a load of an existing virtual storage control device; and
determining, based on the load, the at least one existing virtual control device and the at least part of the virtual logic unit number for which the configuring is performed.

3. The method according to claim 1, wherein the at least one new virtual storage control device is added based on the load of the at least one existing virtual storage control device.

4. The method according to claim 1, further comprising:
monitoring a load of the at least one virtual storage control device in the virtualized storage system; and
configuring, based on the load, at least a part of the virtual logic unit number configured in the at least one virtual storage control device into at least one further virtual storage control device.

5. The method according to claim 5, further comprising:
selecting a path for accessing the part of the virtual logic unit number based on the updated access path when the part of the virtual logic unit number is to be accessed.

6. The method according to claim 4, further comprising:
performing, when the part of the virtual logic unit number is accessed, metadata synchronization among all virtual storage control devices configured with the part of the virtual logic unit number for coordinating the access.

7. An apparatus for storage scale-out in a virtualized storage system, the virtualized storage system comprising at least one virtual control device and at least one storage device, the at least one virtual storage control device being configured to perform virtualized management on the at least one storage device, the apparatus comprising:
an organizing unit configured to,
responsive to at least one new virtual storage control device being added to a virtualized storage system, configure at least a part of a virtual logic unit number configured in at least one existing virtual control device into the at least one new virtual storage control device; and
responsive to the configuring performed by the configuring unit, update an access path for the at least part of the virtual logic unit number, the access path indicating all virtual storage control devices configured with the at least part of the virtual logic unit number.

8. The apparatus according to claim 7, wherein the organizing unit is further configured to:
monitor a load of an existing virtual storage control device; and
determine, based on the load, the at least one existing virtual control device and the at least part of the virtual logic unit number for which the configuring is performed.

9. The apparatus according to claim 7, wherein the at least one new virtual storage control device is added based on the load of the at least one existing virtual storage control device.

10. The apparatus according to claim 7, wherein the organizing unit is further configured to:
monitor a load of at least one virtual storage control device in the virtualized storage system; and
configure, based on the load, at least a part of the virtual logic unit number configured in the at least one virtual storage control device into at least one further virtual storage control device.

11. The apparatus according to claim 10, wherein the organizing unit is further configured to:
select a path for accessing the part of the virtual logic unit number based on the updated access path when the part of the virtual logic unit number is to be accessed.

12. The apparatus according to claim 10, wherein the organizing unit is further configured to:
perform, when the part of the virtual logic unit number is accessed, metadata synchronization among all virtual storage control devices configured with the part of the virtual logic unit number for coordinating the access.

13. A non-transient computer readable storage medium having computer program instructions embodied thereon, the computer program instructions, when being executed, cause a machine to perform a method of storage scale-out in a virtualized storage system, the virtualized storage system comprising at least one virtual storage control device and at least one storage device, the at least one virtual storage control device being configured to perform virtualized management on the at least one storage device, the method comprising:
responsive to at least one new virtual storage control device being added to a virtualized storage system, configuring at least a part of a virtual logic unit number configured in at least one existing virtual control device into the at least one new virtual storage control device; and
responsive to the configuring, updating an access path for the at least one part of the virtual logic unit number, the access path indicating all virtual storage control devices configured with the at least part of the virtual logic unit number.

14. The non-transient computer readable storage medium having computer program instructions according to claim 13, further comprising:
monitoring a load of an existing virtual storage control device; and
determining, based on the load, the at least one existing virtual control device and the at least part of the virtual logic unit number for which the configuring is performed.

15. The non-transient computer readable storage medium having computer program instructions according to claim 13, wherein the at least one new virtual storage control device is added based on the load of the at least one existing virtual storage control device.

16. The non-transient computer readable storage medium having computer program instructions according to claim 13, further comprising:
monitoring a load of the at least one virtual storage control device in the virtualized storage system; and
configuring, based on the load, at least a part of the virtual logic unit number configured in the at least one virtual storage control device into at least one further virtual storage control device.

17. The non-transient computer readable storage medium having computer program instructions according to claim 16, further comprising:
selecting a path for accessing the part of the virtual logic unit number based on the updated access path when the part of the virtual logic unit number is to be accessed.

18. The non-transient computer readable storage medium having computer program instructions according to claim 16, further comprising:
performing, when the part of the virtual logic unit number is accessed, metadata synchronization among all virtual storage control devices configured with the part of the virtual logic unit number for coordinating the access.
